(19) United States
(12) Patent Application Publication
(10) Pub. No.: US 2002/0168056 A1
(43) Pub. Date: Nov. 14, 2002

(54) Voice/data telecommunications system for use with standard telephone interface without a dedicated telephone line

(76) Inventor: Mehmet E. Binal, Trumbull, CT (US)

Correspondence Address: CHARLES N.J. RUGGIERO, ESQ., OHLANDT, GREELEY, RUGGIERO & PERLE, L.L.P., ONE LANDMARK SQUARE, 10th FLOOR, STAMFORD, CT, 06901-2682, US

(21) Appl. No.: 10/188,953

(22) Filed: Jul. 3, 2002

Related U.S. Application Data
(63) Continuation of application No. 09/276,001, filed on Mar. 25, 1999, now abandoned.

(51) Int. Cl. H04M 11/00

(52) U.S. Cl. 379/93.09

(57) ABSTRACT

A voice/data communications systems having voice mail, fax, email and system administration applications. An incoming call is monitored by a signal processor that automatically determines the nature of the incoming signal. Incoming calls with a voice signal are directed to the voice mail application. If the incoming call is a data signal, a switch is controlled to connect the incoming call to an available modem through which the call is routed to an appropriate data application. The system administration application is accessed through the standard telephone interface and the internal modems, thus eliminating the need for a dedicated telephone line to service the system.

### BACKGROUND OF THE INVENTION

1. Field Of The Invention

The present invention relates to voice/data communications systems and, more particularly, to a voice mail system including fax, email and system administration features, in which an internal modem switching arrangement reduces the need for a dedicated telephone line.

Most businesses with more than a few employees employ the services of a voice mail system to manage incoming telephone traffic. The typical voice mail system responds to an incoming call by greeting the caller with a recorded message and offering a menu of options allowing the caller to control the system to perform some limited set of functions. For example, the caller may depress the pound sign, “#”, followed by a three digit extension in hopes of connecting to the phone of a desired call recipient. If the recipient fails to answer, the system allows the caller to leave a message in the recipient's voice mailbox. The systems can also include features for the benefit of the recipients such as call forwarding, multiple mailboxes and remote access of stored messages.

A voice mail system may be implemented as an application program in a personal computer (PC) equipped with some additional signal processing hardware. Because office personnel may change and new features can be added to the voice mail application, the system may routinely require maintenance such as adding or deleting mail boxes, or upgrading the application program.

2. Description of the Prior Art

U.S. Pat. No. 4,856,049 to Streck discloses an apparatus for answering an incoming call and automatically switching the call to either a telephone or a data communication device such as a fax. The apparatus monitors the incoming call, and if a carrier signal is not present, the call is directed to the telephone. If the apparatus detects a carrier signal, the call is directed to the data communication device. This apparatus is primarily a switch that allows a single line to be used by a data communication device in addition to a standard telephone. It does not provide the ability for a single line to be used by a plurality of data communication devices.

U.S. Pat. No. 5,062,133 to Melrose discloses a multi-function call management system serving to interconnect a plurality of data communication devices to a single incoming telephone line. The features included with this system enable the incoming call to be connected to a modem, fax, or answering machine. The system presents the caller with a menu of options. The caller first identifies a desired data communication device, and then the caller initiates a transmission of data over the incoming line.

U.S. Pat. No. 5,490,210 to Sasso discloses a programmable telephone interface device that connects to one telephone line and automatically switches the incoming call to a fax machine or to one of several telephone ports. The device can discriminate between a fax signal and dual tone multi-frequency (DTMF) tones. It decodes and interprets DTMF tones included with the incoming call to identify one of the several telephone ports.

U.S. Pat. No. 5,499,287 to Campbell et al. discloses a telephone interface box that answers incoming calls, automatically determines whether the incoming call is a voice, modem or fax transmission, and directs the call accordingly. The device includes a speech generator and a voice processor. Therefore, the device can make its determination either by detecting tones on the telephone line or by examining the response of the caller to a voice prompt.

Although each of the aforementioned patents are directed towards improving telephone line efficiency, the solutions they offer tend to be localized. That is, they describe devices that are added to a single telephone line thus allowing that line to be put to multiple uses. However, they neither reduce the proliferation of modems on an organizational level nor deal with the redundant allocation of resources among the various data communication systems.

U.S. Pat. No. 5,717,742 to Hyde-Thomas discloses a method for using an existing email system as a voice mail system. It takes advantage of an application program interface of a commercially available email system in which a voice message can be attached to an e-mail message. The existing email system is installed on a PC that includes a board connected to a phone line. The board converts an incoming analog voice signal to a digital file that can be stored on the email system. During playback, the board converts the digital file back to an analog voice signal. This system does not consolidate an email application and a voice mail application into one system, but uses an email application as a means for storing voice messages.

Thus, there is a need for a telecommunications system that consolidates voice and data communications applications into an integrated system. Such a system would reduce the need for telephone lines and modems dedicated to single applications by allowing the applications to share common resources. Additionally, there is a need for an operator to remotely access the system for purposes of system administration without requiring a dedicated telephone line for this purpose.

### SUMMARY OF THE INVENTION

It is an object of the present invention to provide an integrated voice/data communication system that includes a plurality of modems that can be selectively assigned to handle incoming data signals for data processing applications.

It is another object of the present invention to provide such an integrated voice/data communication system that further includes facsimile equipment (fax) and electronic mail (email) capabilities.

It is still another object of the present invention to provide such a system that enables a remote user to service the system without the need for a dedicated telephone line or dedicated modem.

These and other objects of the present invention are achieved by a voice mail system that includes a signal processor, one or more modems, and a cross point switch. The signal processor monitors an incoming call to determine whether the call includes a voice signal or a data signal. If a voice signal is detected, the call is handled by a voice mail/automated attendant. If a data signal is detected, the cross point switch is controlled to direct the call to any available modem, and thereafter the data signal can be used by an appropriate data processing application.

The system also includes fax, email and system administration applications accessible via the selectable modems. Accordingly, when the signal processor determines that an incoming call is a data signal, it further analyzes the signal to identify the application to which the signal should be routed.

Through the system administration application, an operator can remotely access and control the system. Since an internal modem can be assigned to an incoming system administration call, there is no need for a telephone line or separate modem to be dedicated to this application.

### BRIEF DESCRIPTION OF THE DRAWINGS

FIG. 1 is a block diagram of a typical prior art telecommunications suite;

FIG. 2 is a block diagram of a typical prior art telecommunications suite including an array of communications products;

FIG. 3 is a basic block diagram of a telecommunications system configured according to the present invention;

FIG. 3A is a basic block diagram of a telecommunications system, including the capability to manage telephone traffic to and from individual telephones, according to the present invention;

FIG. 4 is a block diagram of a preferred embodiment of a telecommunications system configured according to the present invention;

FIG. 4A is a block diagram of a preferred embodiment of a telecommunications system, including the capability to manage telephone traffic to and from individual telephones, according to the present invention;

FIG. 4B is a block diagram of a telecommunications system according to the present invention, interfacing with a prior art PBX system; and

FIG. 5 is a flowchart of the process according to the present invention for managing an incoming call.

### DESCRIPTION OF THE INVENTION

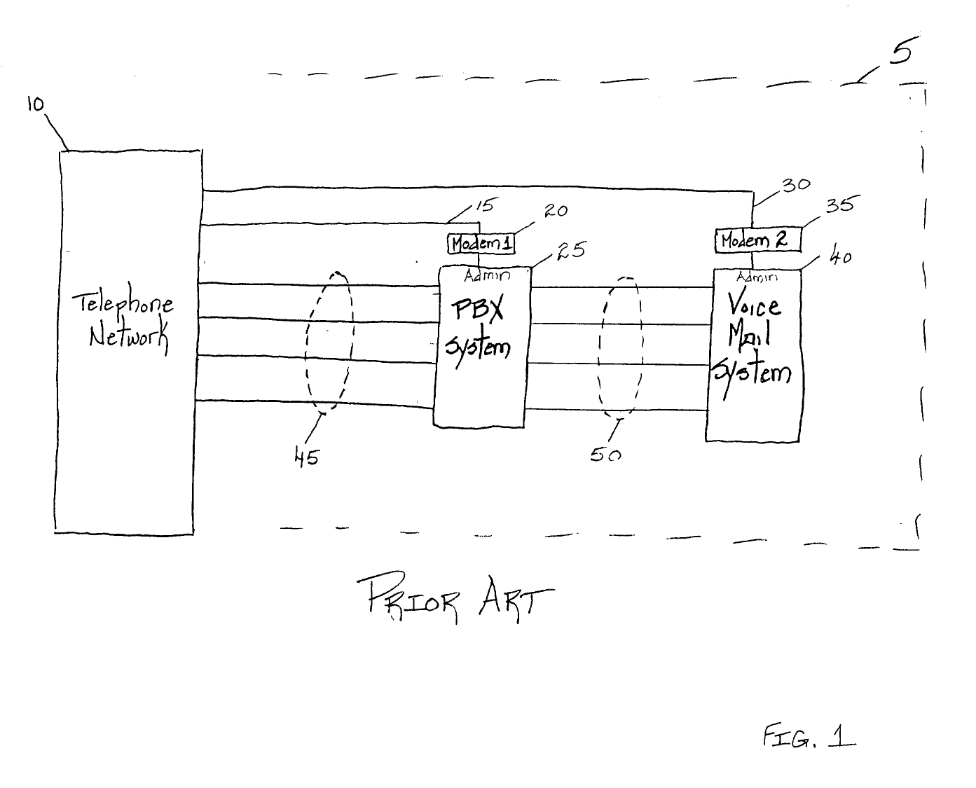

Referring to the figures and, in particular, FIG. 1, there is provided a block diagram of a typical telecommunications suite generally represented by reference number 5. The suite 5 may be found in a business office. The suite 5 has a telephone network 10 that provides one or more analog trunk connections 45 to a private branch exchange (PBX) system 25. Analog line connections 50 connect incoming telephone calls from PBX system 25 to a voice mail system (VMS) 40. Two additional telephone lines 15 and 30, and modems 20 and 35, respectively, enable a remote operator to access system administration applications associated with PBX system 25 and VMS 40.

Because the remote operator may need to perform administrative services at any given time, telephone lines 15 and 30, and modems 20 and 35, must be dedicated to their respective applications. This dedication is inefficient since administrative services, although routine, are performed only occasionally. Consequently, telephone lines 15 and 30, and modems 20 and 35, are idle for a time, generally more time then they are in use. The presence of these telephone lines and modems necessarily increase the overall cost of telecommunications suite 5.

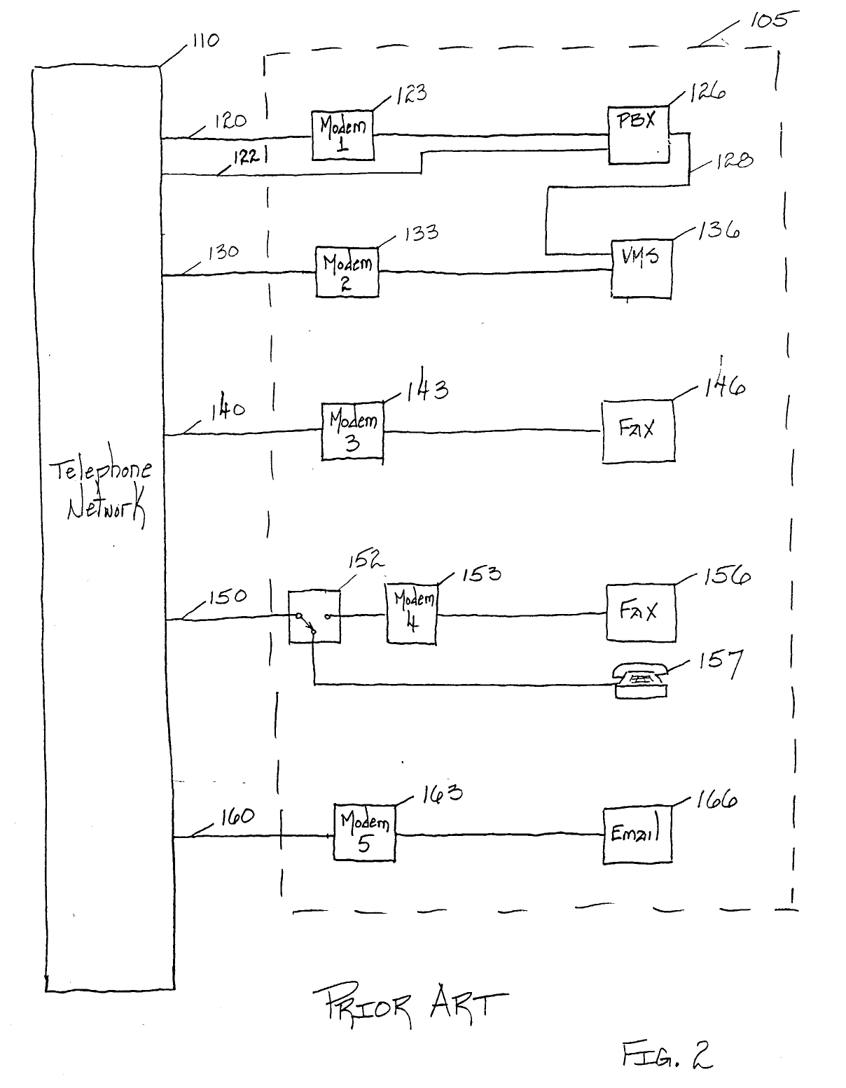

In addition to voice mail, the telecommunications suites 5 of many offices include facsimile equipment (fax), and electronic mail (email). In FIG. 2, telecommunications suite 105 includes an array of communications products, such as, for example, namely PBX 126, VMS 136, faxes 146 and 156, telephone 157 and email system 166. These products are coupled to a telephone network 110 via telephone lines 120, 130, 140, 150 and 160, and modems 123, 133, 143, 153 and 163, respectively. Additionally, telephone calls are routed by trunk lines 122, through PBX 126, via analog line connections 128 into VMS 136. Even though VMS 136, fax 146 and email system 166 have similar or identical telephone system connectivity requirements, i.e. a telephone line and a modem, each is allocated a dedicated set of these resources. Moreover, like a voice mail system, an email system is typically implemented as an application program on a PC, but voice mail and email are often installed on two separate PCs. As the data communication needs of an organization increase, the numbers of telephone lines, modems and computers also tend to increase.

An economic advantage can be realized by reducing the number of dedicated telephone lines and utilizing existing lines more efficiently. Some devices exist in which a single telephone line can be used to service both a regular telephone and a fax machine. For example, in FIG. 2, switch 152 can direct an incoming call from telephone line 150 to either telephone 157 or, via modem 153, to fax 156.

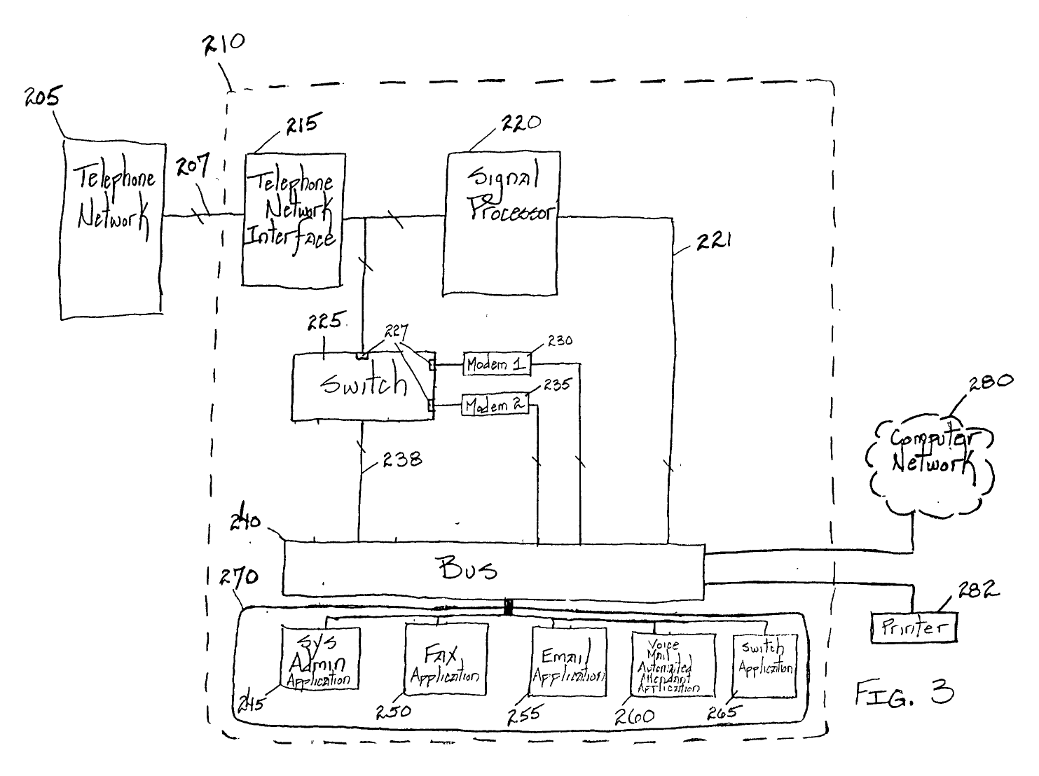

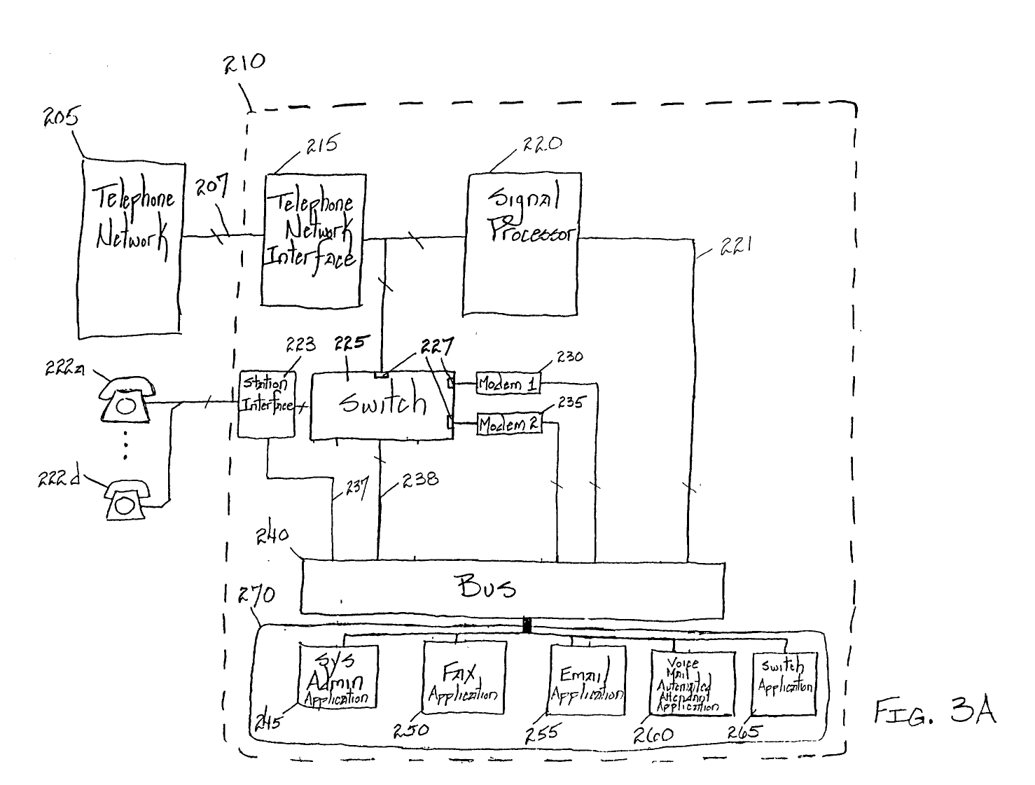

FIG. 3 is a basic block diagram of a telecommunications system configured according to the present invention. Telecommunications system 210 is an integrated system including a telephone network interface 215, a signal processor 220, a switch 225, modems 230 and 235, and a main processor 270. Telephone network interface 215 is connected to signal processor 220 and switch 225. A bus 240 operatively interconnects signal processor 220, switch 225, modems 230 and 235, and main processor 270. Main processor 270 is running a switch application 265, a voice mail/automated attendant application 260, an email application 255, a fax application 250 and a system administration application 245. Telecommunications system 210 could also be coupled to a computer network 280 and connected to a printer 282.

The telephone network interface 215 is coupled to a telephone network 205 via a plurality of analog or digital telephone lines 207. Each telephone line 207 is a standard 2-wire analog telephone line or standard T1, E1 or Integrated Services Digital Network (ISDN) digital line. Telephone network interface 215 monitors each telephone line 207, and produces an “off-hook” signal when an incoming call is detected.

The incoming call is routed from the telephone network interface 215 to a signal processor 220. The signal processor 220 analyzes the incoming call to determine whether the call is a voice signal or a data signal. The result of this determination is communicated from signal processor 220 to voice mail/automated attendant application 260 via bus lines 221 and bus 240. If the incoming call is a voice signal, signal processor 220 and voice mail/automated attendant application 260 operate to direct the call to a voice mailbox. If the incoming call is a data signal, then signal processor 220 determines whether the call includes fax or modem tones and produces a signal indicative thereof.

Switch 225 includes a plurality of bi-directional input/output ports 227, any pair of which can be selectively interconnected. That is, switch 225 can be controlled to connect any port 227 to any other port 227. In response to the signal produced by signal processor 220, switch application 265 controls switch 225, via bus 240 and switch control lines 238, to selectively connect the incoming call from telephone network interface 215 to either modem 230 or 235, whichever is available. Modems 230 and 235 are shared by the various applications 245, 250, 255 and 260. Switch application 265 routes the incoming call from the relevant modem 230 or 235 to the appropriate application via bus 240.

FIG. 3A shows telecommunications system 210 further including the capability to manage telephone traffic to and from individual telephones. An office using this configuration of telecommunications system 210 can eliminate the PBX system of the prior art. A station interface 223 is interposed between switch 225 and telephones 222a-222d. The station interface 223 is also coupled to bus 240 via bus lines 237. Switch application 265 controls switch 225 to connect calls between telephone network interface 215 and station interface 223. The details of this operation are described below.

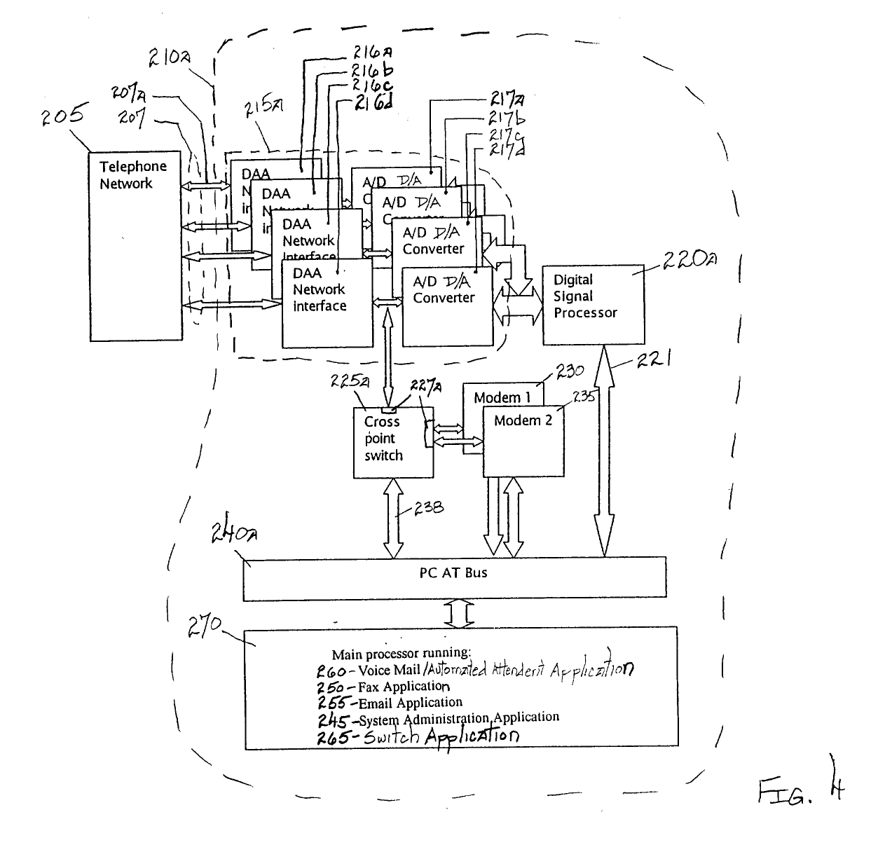

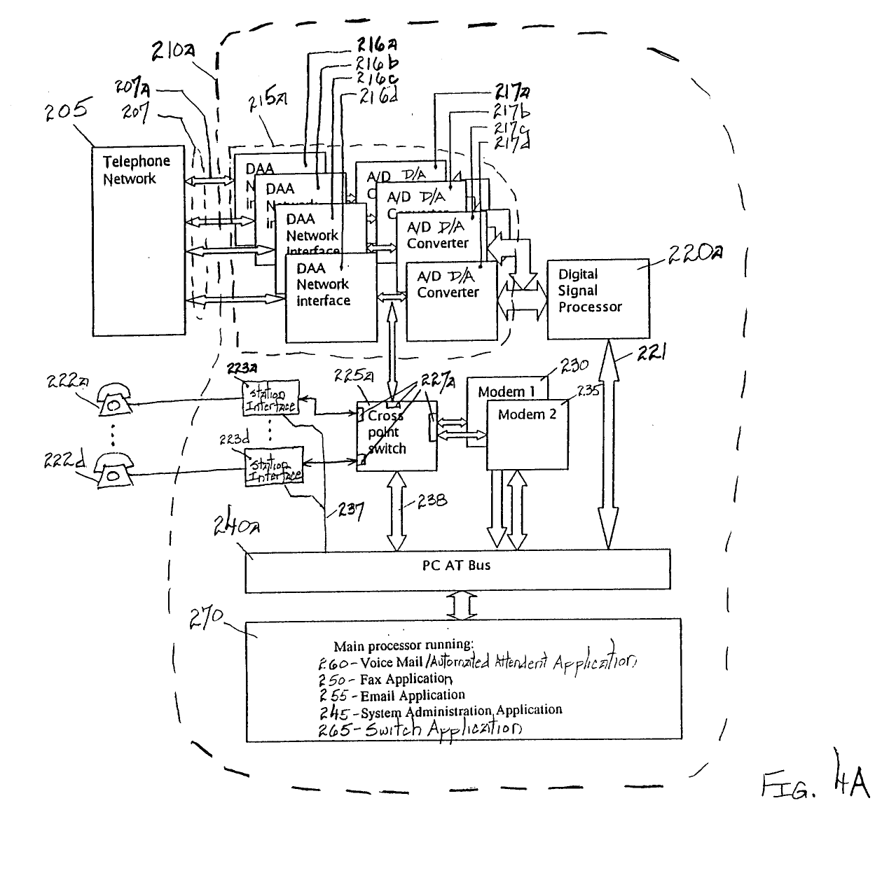

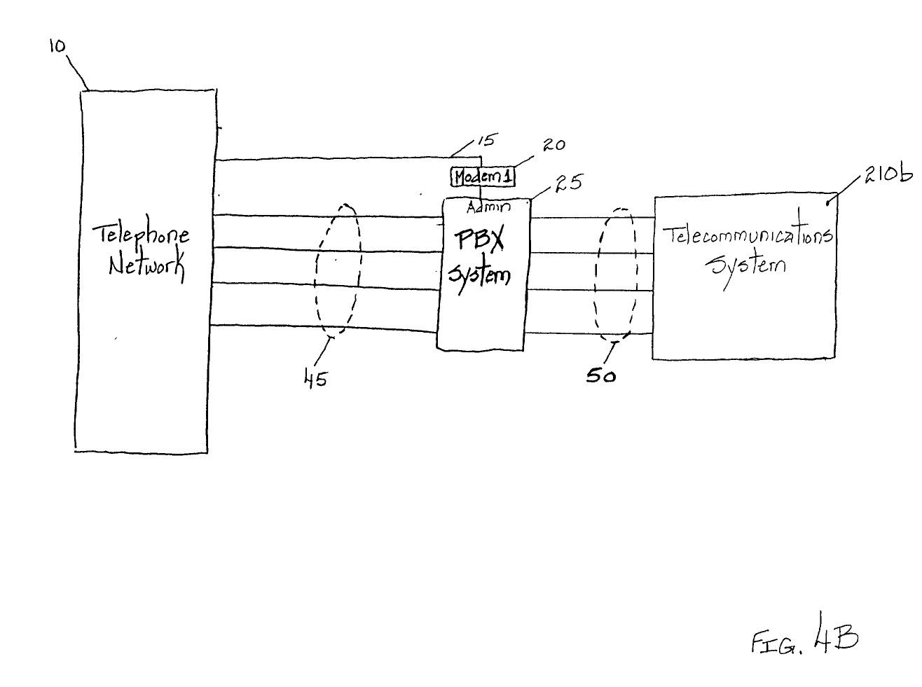

FIG. 4 is a block diagram of a preferred embodiment of a telecommunications system 210a configured according to the present invention. Telecommunications system 210a includes a telephone network interface 215a, a digital signal processor 220a, a cross point switch 225a with a plurality of bi-directional input/output ports 227a, modems 230 and 235, and a main processor 270. Telephone network interface 215a is connected to signal processor 220a and cross point switch 225a. Telecommunications system 210a is implemented on a personal computer (PC) in which a PC AT bus 240a operatively interconnects digital signal processor 220a, cross point switch 225a, modems 230 and 235, and main processor 270.

Main processor 270 is running switch application 265, voice mail/automated attendant application 260, which is the main controlling application, system administration application 245, fax application 250 and email application 255. Fax application 250 and email application 255 are independent programs that are accessed through their respective application program interfaces (API). The system administration application 245 allows a remote operator to access the system for service or maintenance.

Telephone network interface 215a has four data access arrangement (DAA) network interface circuits 216a-216d, with corresponding analog to digital and digital to analog converters (A/D-D/A) 217a-217d. Accordingly, telecommunications system 210a can simultaneously handle four incoming calls. This configuration of four channels is merely representative of one embodiment of the invention. In actual implementation, the number of channels will be based on the level of telephone traffic that the system will be expected to handle. Also, if telephone network 205 provided signals in a digital format, DAA's 216a-216d would be adapted to receive signals in a digital format, and A/D-D/A's 217a-217d would not be necessary.

When an incoming call is received through telephone line 207a, DAA 216a produces an “off-hook” signal. The incoming signal is routed from DAA 216a to A/D-D/A 217a where it is converted from analog to digital and thereafter routed to digital signal processor 220a. Digital signal processor 220a notifies voice mail/automated attendant application 260 of the incoming call. Voice mail/automated attendant application 260 sends a greeting message to digital signal processor 220a, which forwards the message through A/D-D/A 217a to DAA 216a. The greeting message is presented to the caller.

Digital signal processor 220a receives and processes incoming signals from all four A/D-D/A's 217a-217d. It distinguishes between the various incoming signal formats by detecting and interpreting fax (CNG) signals and modem tones. Additionally, in the case of a voice signal, it is responsible for recognizing the spoken responses and commands of the calling party. After determining the incoming signal format, digital signal processor 220a communicates the result to voice mail/automated attendant application 260.

Crosspoint switch 225a can be controlled to connect any port 227a to any other port 227a. Accordingly, voice mail/automated attendant application 260 communicates instructions to switch application 265 to control cross point switch 225a to connect the output of any of the four DAA's 216a-216d to either of the modems 230 or 235. The modems 230 and 235 are coupled to main processor 270 via PC AT bus 240a. Therefore, modems 230 and 235 can be used to route an incoming call to any data application, i.e., system administration application 245, fax application 250, and email application 255. This use of cross point switch 225a in cooperation with modems 230 and 235 reduces the number of modems as compared to the prior art because it allows modems 230 and 235 to be shared among the various applications. Additionally, by enabling a signal from either modem 230 or 235 to be directed to system administration application 245, the dedicated telephone line required to service prior art systems has also been eliminated.

Main processor 270 is a computer processor with its associated memory, running under the control of an operating system having multi-threading or multi-processing capability. Accordingly, telecommunications system 210a can simultaneously run several different applications or several instances of a single application, and can therefore handle simultaneous incoming calls. For example, assume three incoming calls arrive separated by time intervals of a few seconds. The first call can be serviced by voice mail/automated attendant application 260, the second call can be serviced by fax application 250, and concurrently, the third call can also be serviced by fax application 250.

FIG. 4A shows telecommunications system 210a further including the capability to manage telephone traffic to and from individual telephones. An office using this configuration of telecommunications system 210a eliminates the need for a PBX system of the prior art. Telephones 222a-222d are connected to station interfaces 223a-223d, respectively, which are coupled to cross point switch 225a.

As discussed above, an incoming call with a voice signal will be recognized by digital signal processor 220a, which will alert voice mail/automated attendant application 260. Thereafter, the caller will interface with voice mail/automated attendant application 260 and signal processor 220a to indicate a desired destination for the incoming call. If, for example, the caller wishes for the call to be directed to telephone 222a, voice mail/automated attendant application 260 will instruct switch application 265 to control cross point switch 222a to connect the incoming call from the appropriate DAA 216a-216d to station interface 223a.

Telecommunications system 210a also handles calls that originate from telephones 222a-222d. For example, a caller at telephone 222a may wish to access an outside line through telephone network 205, or an inside line such as telephone 222d. A caller at telephone 222a initiates a call by dialing a desired destination. Dialing signals are sent from telephone 222a to station interface 223a and relayed to digital signal processor 220a via bus lines 237, bus 240a, and bus lines 221.

If the destination is an outside line, digital signal processor 220a connects to an available A/D-D/A 217a-217d and its corresponding DAA 216a-216d, and transmits the dialing signals to telephone network 205. If it is assumed the connection has been made through A/D-D/A 217a and DAA 216a, digital signal processor then instructs switch application 265 to control cross point switch 225a to connect station interface 223a to DAA 216a.

If the desired destination for the call is telephone 222d, digital signal processor 220a instructs switch application 265 to control cross point switch 225a to connect station interface 223a to station interface 223d.

The representation of four telephones 222a-222d in FIG. 4A is only for purposes of illustration. The number of telephones managed by telecommunications system 210a is not limited to any particular quantity.

FIG. 4B shows an alternative embodiment of a telecommunications system 210b in operation with a prior art PBX system 25. Note that as compared to the prior art system shown in FIG. 1, this arrangement does not require a dedicated telephone line 30 and modem 35. In this application, telecommunications system 210b would not necessarily be called upon to manage calls to or from inside telephones as shown in FIG. 4B. Instead, telecommunications system 210b is used for its centralized voice mail, email, and fax capabilities, and as a secondary destination for incoming calls when a primary destination is not available.

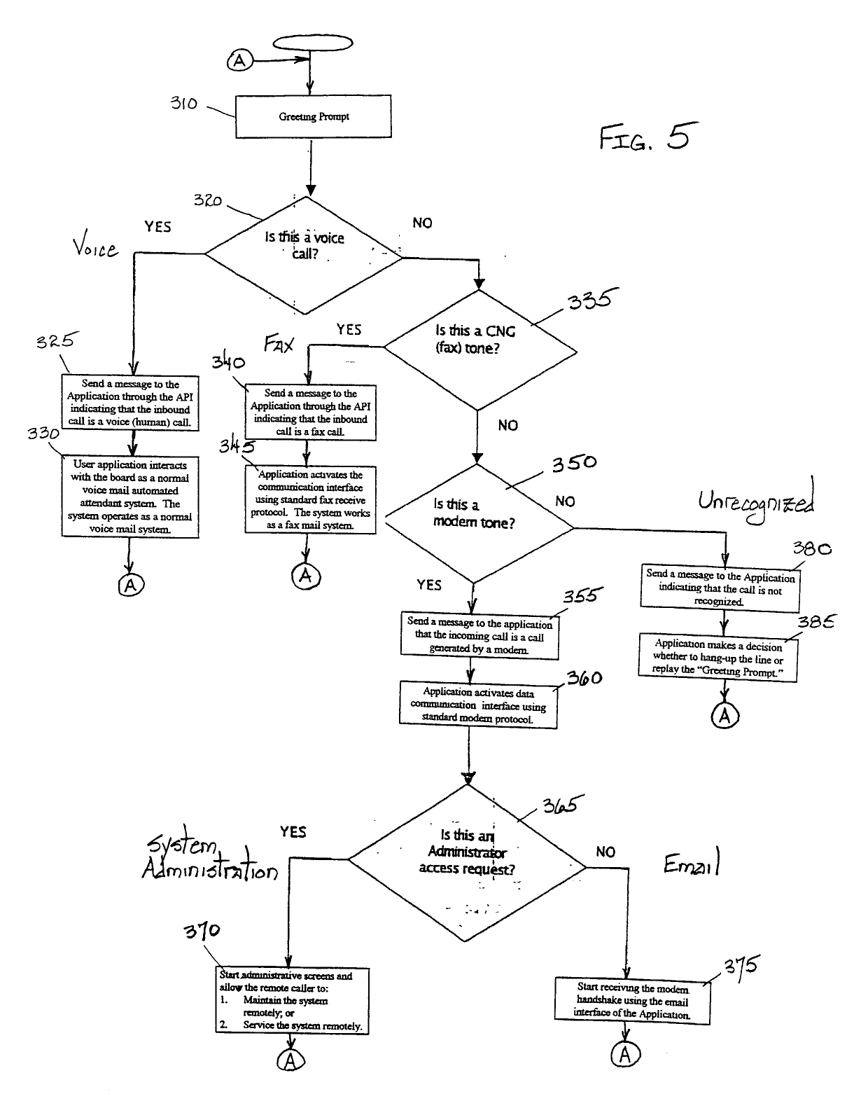

FIG. 5 is a flowchart of the process for managing an incoming call according to the present invention. The process manages five categories of incoming calls, namely, voice mail (steps 325-330), fax (steps 340-345), system administration (step 370), email (step 375) and unrecognized (steps 380-385).

In step 310, when an incoming call is first detected, the system plays a greeting prompt to the caller. The process then advances to step 320.

In step 320, the digital signal processor determines whether the incoming call is a voice signal. If the incoming call is a voice signal, then the process advances to step 325. If the incoming call is not a voice signal, then the process advances to step 335.

In step 325, the digital signal processor sends a message to the voice mail/automated attendant application indicating that the caller is a human. The process then advances to step 330.

In step 330, the caller interacts with the voice mail/automated attendant application to direct the call to a voice mailbox or telephone. Thereafter, the process loops back to step 310.

In step 335, the digital signal processor determines whether the incoming call includes a fax (CNG) tone. If the incoming call includes a CNG tone, then the process advances to step 340. If the incoming call does not include a CNG tone, then the process advances to step 350.

In step 340, the digital signal processor sends a message to the main application indicating that the incoming call is associated with the fax application. The process then advances to step 345.

In step 345, the cross point switch 225a is controlled to connect the incoming call to an available modem, and the fax application handles the incoming call through a fax API. Thereafter, the process loops back to step 310.

In step 350, the digital signal processor determines whether the incoming call includes modem tones. If the incoming signal includes modem tones, then the process advances to step 355. If the incoming call does not include modem tones, then the process advances to step 380.

In step 355, the digital signal processor sends a message to the voice mail/automated attendant application indicating that the incoming call is generated by a modem. The process then advances to step 360.

In step 360, the cross point switch 225a is controlled to connect the incoming call to an available modem and the voice mail/automated attendant application receives the incoming call through a data communications interface using standard modem protocol. The process then advances to step 365.

In step 365, the voice mail/automated attendant application determines whether the incoming call is for system administration. If the incoming call is for system administration, then the process advances to step 370. If the incoming call is not for system administration, then the process advances to step 375.

In step 370, the system administration application handles the incoming call. Thereafter, the process loops back to step 310.

In step 375 the email application handles the incoming call through an email API. Thereafter, the process loops back to step 310.

In step 380, the digital signal processor sends a message to the voice mail/automated attendant application indicating that the incoming call is not recognized. The process then advances to step 385.

In step 385, the voice mail/automated attendant application decides to either terminate or continue servicing the call. In either case, the process thereafter loops back to step 310.

The voice/data telecommunications system 210a of the present invention is a novel combination of a voice mail application, a switching application and a cross point switch that selectively routes incoming calls to either modem 230 or 235, thus enabling email, fax processing, and system administration capabilities.

It should be understood that various alternatives and modifications can be devised by those skilled in the art without departing from the invention. For example, depending on the volume of telephone traffic of the organization where the system is installed, the number of DAA's can be other than four, and the number of modems can be more or less than two. Also, the modem signals can be used for other applications or directed to external devices. Accordingly, the present invention is intended to embrace all such alternatives, modifications and variances that fall within the scope of the appended claims.

What is claimed is:

1. A telecommunications system for managing communications from a telephone network having one or more telephone lines, the telecommunications system comprising:
means, coupled to said telephone network, for determining whether an incoming call is a voice signal or a data signal, and providing an identification signal indicative thereof;
means, coupled to said telephone network, operating in cooperation with a voice mail application, for processing said voice signal;
means, embodying a data application, for processing said data signal;
a modem coupled to said data signal processing means;
means for selectively routing said incoming call to said modem; and
means, coupled to said determining means and responsive to said identification signal, for controlling said routing means to divert said incoming call to said modem.

2. The telecommunications system of claim 1, wherein said data application comprises at least one of a fax application, an email application or a system administration application.

3. The telecommunications system of claim 2, wherein said system administration application has means controllable by a remote user to maintain and service the telecommunications system.

4. The telecommunications system of claim 2, wherein said determining means determines and indicates whether said incoming call is associated with said fax application, said email application, or said system administration application.

5. The telecommunications system of claim 1, further comprising means, coupled to said telephone network and responsive to said incoming call on any of said one or more telephone lines, for establishing a call connection and coupling said incoming call to said routing means.

6. The telecommunications system of claim 5, wherein said establishing means produces an off-hook signal when establishing said call connection.

7. The telecommunications system of claim 1, further comprising means, coupled to said selective routing means, for connecting a call to one or more telephones.

8. The telecommunications system of claim 7, wherein said controlling means controls said selective routing means to route said call between said telephone network and said connecting means.

9. The telecommunications system of claim 8, wherein said selective routing means routes said call between said telephone network and said connecting means.

10. The telecommunications system of claim 1, wherein said selective routing means comprises a plurality of input/output ports, and is controlled to route a signal between any pair of said plurality of input/output ports.

11. A telecommunications system for managing communications from a telephone network having a plurality of telephone lines, the telecommunications system comprising:
means, coupled to said telephone network, for determining whether an incoming call is a voice signal or a data signal, and providing an identification signal indicative thereof;
means, coupled to said telephone network, operating in cooperation with a voice mail application, for processing said voice signal;
means, embodying a data application, for processing said data signal;
a plurality of modems coupled to said data signal processing means;
means for selectively routing said incoming call to any of said plurality of modems; and
means, coupled to said determining means and responsive to said identification signal, for controlling said routing means to divert said incoming call to any of said plurality of modems.

12. The telecommunications system of claim 11, wherein said data application comprises at least one of a fax application, an email application or a system administration application.

13. The telecommunications system of claim 12, wherein said system administration application has means controllable by a remote user to maintain and service the telecommunications system.

14. The telecommunications system of claim 12, wherein said determining means determines and indicates whether said incoming call is associated with said fax application, said email application, or said system administration application.

15. The telecommunications system of claim 11, further comprising means, coupled to said telephone network and responsive to said incoming call on any of said plurality of telephone lines, for establishing a call connection and coupling said incoming call to said routing means.

16. The telecommunications system of claim 15, wherein said establishing means comprises a plurality of telephone network interfaces, each capable of producing an off-hook signal when establishing said call connection.

17. A telecommunications system for managing communications from a telephone network having a plurality of telephone lines, the telecommunications system comprising:
means, coupled to said telephone network and responsive to said incoming call on any of said plurality of telephone lines, for establishing a call connection;
means, coupled to said establishing means, for determining whether an incoming call is a voice signal or a data signal, and providing an identification signal indicative thereof;
means, operating in cooperation with a voice mail application, for processing said voice signal;
means, embodying a data application, for processing said data signal;
a plurality of modems coupled to said data signal processing means;
means for selectively routing said incoming call to any of said plurality of modems; and
means, coupled to said determining means and responsive to said identification signal, for controlling said routing means to divert said incoming call to any of said plurality of modems,
wherein none of said plurality of telephone lines or said plurality of modems is dedicated to any one of said data applications.

18. The telecommunications system of claim 17, wherein said determining means comprises a digital signal processor.

19. The telecommunications system of claim 18, further comprising a plurality of converters, interposed between said establishing means and said digital signal processor, for converting analog signals from said establishing means to digital signals for said digital signal processor, and for converting digital signals from said digital signal processor to analog signals for said establishing means.

20. The telecommunications system of claim 17, wherein said data application comprises at least one of a fax application, an email application or a system administration application.

21. The telecommunications system of claim 20, wherein said determining means determines and indicates whether said incoming call is associated with said fax application, said email application, or said system administration application.
